(19) United States
(12) Patent Application Publication
(10) Pub. No.: US 2016/0118926 A1
(43) Pub. Date: Apr. 28, 2016

(54) MOTOR DRIVING APPARATUS AND CLEANER MOTOR APPARATUS USING THE SAME

(71) Applicant: SAMSUNG ELECTRO-MECHANICS CO., LTD., Suwon-si (KR)

(72) Inventors: Kyu Dong KIM, Seosan-si (KR); Geun Hong LEE, Seoul (KR); Joung Ho SON, Seoul (KR)

(73) Assignee: SAMSUNG ELECTRO-MECHANICS CO., LTD., Suwon-si (KR)

(21) Appl. No.: 14/886,414

(22) Filed: Oct. 19, 2015

(30) Foreign Application Priority Data
Oct. 24, 2014 (KR) 10-2014-0144680

(51) Int. Cl. H02P 29/00; A47L 9/28; H02P 6/14

(52) U.S. Cl. CPC H02P 29/00; H02P 6/145; A47L 9/2884; A47L 9/2842; A47L 9/2889

(57) ABSTRACT

There is provided a motor driving apparatus comprising: a timer configured to output a time information; and a control unit configured to decrease a speed of a motor, after determining, based on the time information, that a driving time of the motor has elapsed for a predetermined period of time.

### CROSS-REFERENCE TO RELATED APPLICATIONS

Claim and incorporate by reference domestic priority application and foreign priority application as follows:

### Cross Reference To Related Application

This application claims the foreign priority benefit under 35 U.S.C. Section 119 of Korean Patent Application Serial No. 10-2014-0144680, entitled filed Oct. 24, 2014, which is hereby incorporated by reference in its entirety into this application.

### BACKGROUND OF THE INVENTION

1. Field of the Invention

Embodiments of the present invention relates to a motor driving apparatus and a cleaner motor using the same.

2. Description of the Related Art

A cleaner generates a vacuum condition by virtue of a rotational force of a built-in motor. The cleaner sucks air or dust by virtue of a vacuum suction force generated thus, and discharges the air outside while collecting the dust therein. The cleaner is used at any locations based on power applied to the motor through a battery. However, when the suction force of the cleaner is decreased, the cleaner fails to smoothly removing the dust. In recent years, an approach has been taken to raise the suction force through the use of a motor having high-current/high-power of 700 W class. However, in a cleaner using such a motor, a temperature of the motor may be increased when the motor operates at the maximum speed. In addition, a charging time of the battery is about 2 hours. When the cleaner continues to use for about 13 minutes, it is not able to use for a long period of time. As such, the cleaner provided with the battery is not used widely.

### SUMMARY OF THE INVENTION

The present invention has been invented in order to overcome the above-described problems and it is, therefore, an object of the present invention to provide a motor driving apparatus and a cleaner motor apparatus using the same, which are capable of increasing a life of a battery.

In accordance with a first embodiment of the present invention to achieve the object, there is provided a motor driving apparatus comprising: a timer configured to output a time information; and a control unit configured to decrease a speed of a motor, if it is determined that a driving time of the motor has elapsed for a predetermined period of time based on the time information.

In accordance with a second embodiment of the present invention to achieve the object, there is provided a cleaner motor apparatus comprising: a motor; a battery configured to supply power to the motor; and a driving unit configured to drive the motor, wherein the driving unit includes a control unit configured to decrease a speed of the motor, if it is determined that a driving time has elapsed for a predetermined period of time based on a time information.

In accordance with a third embodiment of the present invention to achieve the object, there is provided a method of driving a motor driving apparatus, the method comprising: determining whether or not a driving time of a motor has elapsed for a predetermined period of time; determining a speed of the motor, if it is determined that the driving time of the motor has elapsed for the predetermined period of time; decreasing the speed of the motor, if it is determined that the determined speed is equal to or higher than a predetermined speed.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a structural view showing a motor apparatus according to an embodiment of the present disclosure;

FIG. 2 a structural view showing an embodiment of a control unit shown in FIG. 1; and

FIG. 3 is a flow chart showing an example of an operation of a motor shown in FIG. 2.

### DESCRIPTION OF EMBODIMENTS

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

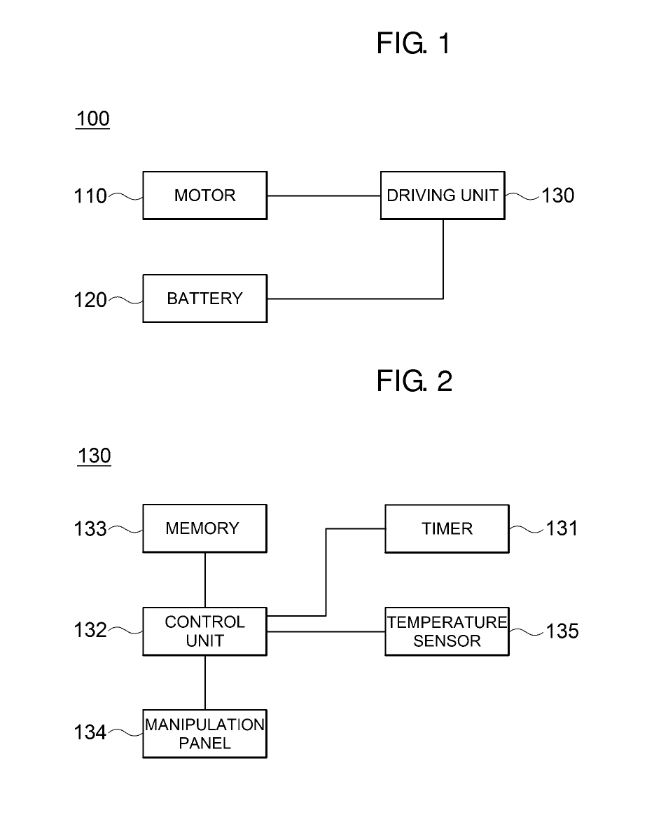

FIG. 1 is a structural view showing a motor apparatus according to an embodiment of the present disclosure.

Referring to FIG. 1, a cleaner motor apparatus 100 includes a motor 110, a battery 120 for supplying the motor 110, a driving unit 130 configured to drive the motor 110

The motor 110 rotates a rotation shaft thereof based on a power supplied thereto such that a cleaner sucks dust together with air for cleaning. The operation of the motor 110 is not limited to the suction of the dust. The motor 110 may operate based on a power supplied from the battery 120. The battery 120 supplies a charged power to the motor 110 so that a driving time of the motor 120 is limited. This restricts a continuous operation of the cleaner provided with the motor apparatus 100. To solve this problem, the driving unit 130 is configured to control the speed of the motor 110. A consumption power of the motor 110 may be varied according to a speed of the motor 110. Thus, the control of the speed of the motor 110 increases the driving time of the motor 110 even when the same amount of power is used. Further, when the driving time of the motor 110 is over a predetermined period of time, the driving unit 130 decreases the speed of the motor 110, thereby prolonging a life of the battery 120. Thus, the driving time of the set time is increased. At this time, the decrease of the speed of the motor 110 may decrease a suction force of the cleaner. Therefore, only when the speed of the motor 110 is highest, the speed of the motor 110 is lowered after a predetermined period of time has elapsed, thus increasing the operating time of the battery 120.

FIG. 2 is a structure view showing the driving unit 130 included in the cleaner motor apparatus 100 shown in FIG. 2.

Referring to FIG. 2, the driving unit 130 includes a timer 131 for outputting a time information, and a control unit 132 configured to decrease the speed of the motor 110 after the driving time of the motor 110 reaches a predetermined period of time based on the time information. The timer 131 counts time starting at the start of the driving of the motor 110, produces the time information for the driving time of the motor 110, and outputs the same. While the motor 110 operates at the maximum speed, the control unit 132 determines whether or not the driving time of the motor 110 is over the predetermined period of time. If so, the control unit 132 decreases the speed of the motor 110. In this case, the driving time of the motor 110 may be a time for which the motor 110 operates at the maximum rotation speed.

Further, the control unit 132 further includes a memory 133 storing a motor information. The control unit 132 is configured to check the driving time of the motor 110 based on the information recorded in the memory 133 and determine whether or not or not the driving time of the motor 110 is over based on the time information provided from the timer 131. If it is determined that the driving time of the motor 110 is over, the control unit 132 outputs a control signal for decreasing the speed of the motor 110. The driving time of the motor 110 may be determined based on the output of the motor 110 or the like. In addition, the memory 133 may store information associated with a charge level of the battery 120. The control unit 132 may determine the driving time of the motor 110 based on the battery information and the motor information. At this time, the control unit 132 may decrease the speed of the motor 110 by changing an advance angle of the motor 110 based on the control signal. In addition, the motor information may include a plurality of set levels corresponding to respective speeds of the motor 110 and advance angles of the motor 110 that correspond to the respective levels. Thus, the control unit 132 controls the speed of the motor 110 based on the advance angles that are set for the respective levels. If it is determined that a period of time at the advance angle is maintained, i.e., a period of time during which the speed of the motor 110 is maintained at maximum, is over a predetermined period of time, the control unit 132 changes the advance angle corresponding to the maximum speed into another advance angle that is one-level lowered than the maximum speed. The maximum speed of the motor 110 is a speed at which the motor 110 rotates at maximum, but is not limited thereto. As an example, the maximum speed may be the fastest one of speeds corresponding to the plurality of set levels set in the control unit 132. Alternatively, the maximum speed may be the next fastest one of speeds corresponding to the plurality of set levels which is one-level lowered than the maximum speed.

In one embodiment, the control unit 132 may control such that the advance angle corresponding to the maximum speed is not changed immediately into another advance angle corresponding to a one-level lowered speed, thus avoiding experience of speed change. Further, the control unit 132 outputs a control signal to change a current advance angle into a target advance angle based on the control signal, wherein, after being changed into at least one advance angle between the current advance angle and the target advance angle, it can be changed into the target advance angle. Here, the current advance angle is an angle corresponding to the maximum speed and the target advance angle is an angle corresponding to a one-level lowered speed than the maximum speed. In some embodiments, the target advance angle may be set by decreasing a one degree per one step from the current advance angle of the motor 110. In addition, the motor 110, the driving unit 130 and the like may be damaged by heat generated by the driving of the motor 110. To address this, the control unit 132 senses the heat and stops the driving of the motor 110 responsive to the sensed heat. This presents the cleaner from being stopped due to the stop of the motor 110. Further, the heat is reduced by decreasing a period of time for which the motor 110 operates at the maximum speed, thus eliminating an event that the driving of the motor 110 is stopped.

In one embodiment, the control unit 132 includes a manipulation panel 134. Examples of the manipulation panel 134 may include a switch or the like. A signal obtained at the manipulation panel 134 by manipulation of a user is provided to the control unit 132 such that the motor 110 operates at a speed set by the user. In some embodiments, the number of levels of the motor 110 may be determined through the manipulation panel 134 so that the speed of the motor 110 is determined.

In one embodiment, the control unit 132 includes a temperature sensor 135. The temperature sensor 135 is configured to measure an ambient temperature or a surface temperature of the motor 110 and generates a related temperature information which is to be transmitted to the control unit 132. Based on the related temperature information, the control unit 132 stops the driving of the motor 110 to prevent the motor 110 from being undergone overheating. In addition, the control unit 132 may reduce the speed of the motor 110. Further, the control unit 132 may reduce the speed of the motor 110 by adjusting the advance angle.

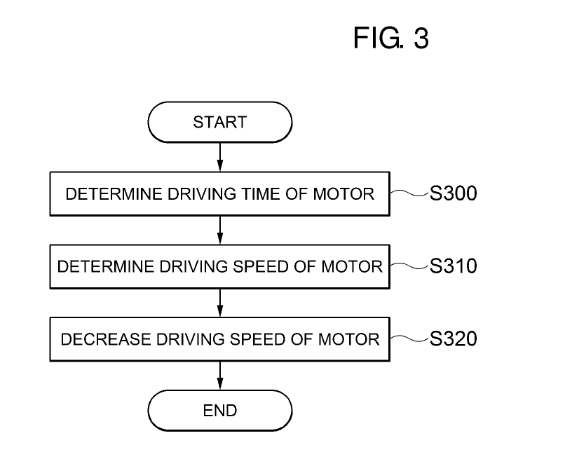

FIG. 3 is a flow chart showing an example of an operation of the motor shown in FIG. 2.

Referring to FIG. 3, the cleaner motor apparatus 100 determines whether or not the driving time of the motor 110 has elapsed for a predetermined period of time (S300). The cleaner motor apparatus 100 may determine whether or not the driving time of the motor 110 has elapsed for the predetermined period using the timer 131. The timer 131 starts counting time from the start of driving of the motor 110 and outputs a time information for the driving time of the motor 110.

If it is determined that the predetermined period of time has elapsed, the control unit 132 determines the speed of the current motor 110 (S310). The speed of the current motor 110 may be determined based on the advance angle of the motor 110. When the speed of the current motor 110 is determined to be equal to or higher than a predetermined speed, the speed of the motor 110 is decreased. In this case, the predetermined speed may be the maximum speed of the motor 110, and the decreased speed may be a one-level lowered speed than the maximum speed. The decrease of the speed of the motor 110 may be achieved by changing the advance angle. In one embodiment, the advance change is changed from the current advance angle to the target advance angle. Further, at least one of angles between the current advance angle and the target advance angle may be changed to the target advance angle. In some embodiments, an angle lowered by one step from the current advance angle of the motor 110 may be set to the target advance angle corresponding to the target speed.

In the above, functions of respective components shown in the drawings may be implemented by using a hardware on where a related software can be executed, or a dedicated hardware. Further, the functions may be implemented by a single dedicated processor, a single share processor, a plurality of processors some of which may be shared by each other.

According to the present disclosure in some embodiments, it is possible to prolong a life of a battery and suppress an increase in temperature generated by using a motor for a long period of time, thus preventing the motor from being stopped in use, and also, reducing noise.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

1. A motor driving apparatus comprising:
a timer configured to output a time information; and
a control unit configured to decrease a speed of a motor, after determining, based on the time information, that a driving time of the motor has elapsed for a predetermined period of time.

2. The motor driving apparatus according to claim 1, wherein the driving time is a period of time for which the motor operates at maximum speed.

3. The motor driving apparatus according to claim 1,
wherein the control unit further includes a memory configured to store a motor information;
wherein the control unit is configured to check a driving time assigned to the motor, based on the motor information recorded in the memory; and
wherein the control unit is configured to output a control signal to decrease the speed of the motor, after determining that the driving time has elapsed, based on the time information provided from the timer.

4. The motor driving apparatus according to claim 3, wherein the control unit is configured to decrease the speed of the motor, by changing an advance angle of the motor, based on the control signal.

5. The motor driving apparatus according to claim 3,
wherein the motor information includes a plurality of set levels, and advance angles of the motor that are assigned for respective levels,
wherein the control unit is configured to determine the speed of the motor corresponding to the respective level, based on the motor information.

6. The motor driving apparatus according to claim 4,
wherein the control unit is configured to change a current advance angle to a target advance angle, based on the control signal, and
wherein after being changed into at least one advance angle between the current advance angle and the target advance angle, the current advance angle is changed into the target advance angle.

7. A cleaner motor apparatus comprising:
a motor;
a battery configured to supply power to the motor; and
a driving unit configured to drive the motor,
wherein the driving unit includes a control unit configured to decrease a speed of the motor, after determining, based on a time information, that a driving time has elapsed for a predetermined period of time.

8. The cleaner motor apparatus according to claim 7, wherein the driving unit includes a timer for generating the time information.

9. The cleaner motor apparatus according to claim 7, wherein the driving time is a period of time for which the motor operates at a maximum speed.

10. The cleaner motor apparatus according to claim 8,
wherein the control unit further includes a memory configured to store a motor information,
wherein the control unit is configured to check a driving time assigned to the motor, based on the motor information recorded in the memory, and to output a control signal to decrease the speed of the motor, after determining that the driving time has elapsed, based on the time information provided from the timer.

11. The cleaner motor apparatus according to claim 10, wherein the control unit is configured to decrease the speed of the motor, by changing an advance angle of the motor, based on the control signal.

12. The cleaner motor apparatus according to claim 10,
wherein the motor information includes a plurality of set levels, and advance angles of the motor that are assigned for respective levels,
wherein the control unit is configured to determine the speed of the motor corresponding to the respective level, based on the motor information.

13. The cleaner motor apparatus according to claim 11,
wherein the control unit is configured to change a current advance angle to a target advance angle, based on the control signal, and
wherein after being changed into at least one advance angle between the current advance angle and the target advance angle, the current advance angle is changed into the target angle.

14. A method of driving a motor driving apparatus, comprising:
determining whether or not a driving time of a motor has elapsed for a predetermined period of time;
determining a speed of the motor, after determining that the driving time of the motor has elapsed for the predetermined period of time; and
decreasing the speed of the motor, after determining that the determined speed is equal to or higher than a predetermined speed.

15. The method of driving the motor driving apparatus according to claim 14, wherein the speed of the motor is determined based on an advance angle of the motor.

16. The method of driving the motor driving apparatus according to claim 14,
wherein decreasing the speed of the motor includes changing a current advance angle to a target advance angle, and
wherein after being changed into at least one advance angle between the current advance angle and the target advance angle, the current advance angle is changed into the target advance angle.
